(19) United States
(12) Patent Application Publication
(10) Pub. No.: US 2026/0238533 A1
(43) Pub. Date: Aug. 13, 2026

(54) OPPORTUNISTIC TRANSMISSION OF REFERENCE SIGNALS

(71) Applicant: QUALCOMM Incorporated, San Diego, CA (US)

(72) Inventors: Jing DAI, Beijing (CN); Hung Dinh LY, San Diego, CA (US); Chao WEI, Beijing (CN)

(21) Appl. No.: 19/470,942

(22) PCT Filed: May 11, 2023
(86) PCT No.: PCT/CN2023/093471

§ 371 Date: Sep. 30, 2025

(51) Int. Cl. H04L 27/26; H04L 5/00; H04W 76/28

(52) U.S. Cl. CPC H04L 27/261; H04L 5/0044; H04W 76/28

(57) ABSTRACT

Certain aspects of the present disclosure provide techniques for opportunistic transmission of periodic reference signals. An example method, performed at a user equipment (UE), includes receiving first signaling configuring the UE with a first set of reference signal (RS) resources for periodic transmission of RS and at least a second set of periodic RS resources for opportunistic transmission of RS, receiving second signaling indicating when RS will be transmitted in a transmission occasion of the second set of RS resources, calculating a time correlation metric based on measurement of RS transmitted in the transmission occasion of the second set of RS resources, in accordance with the second signaling, and a measurement of RS transmitted in a transmission occasion of the first set of RS resources, and transmitting a report indicating the time correlation metric.

### BACKGROUND

### Field of the Disclosure

Aspects of the present disclosure relate to wireless communications, and more particularly, to techniques for opportunistic transmission of reference signals (RS).

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communications at a user equipment (UE). The method includes receiving first signaling configuring the UE with a first set of reference signal (RS) resources for periodic transmission of RS and at least a second set of periodic RS resources for opportunistic transmission of RS; receiving second signaling indicating when RS will be transmitted in a transmission occasion of the second set of RS resources; calculating a time correlation metric based on measurement of RS transmitted in the transmission occasion of the second set of RS resources, in accordance with the second signaling, and a measurement of RS transmitted in a transmission occasion of the first set of RS resources; and transmitting a report indicating the time correlation metric.

Another aspect provides a method for wireless communications at a network entity. The method includes transmitting first signaling configuring a user equipment (UE) with a first set of reference signal (RS) resources for periodic transmission of RS and at least a second set of periodic RS resources for opportunistic transmission of RS; transmitting second signaling indicating when RS will be transmitted in a transmission occasion of the second set of RS resources; and receiving a report indicating a time correlation metric calculated by the UE based on measurement of RS transmitted in the transmission occasion of the second set of RS resources, in accordance with the second signaling, and a measurement of RS transmitted in a transmission occasion of the first set of RS resources.

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIGS. 5A and 5B depict example timing diagrams for discontinuous reception (DRX) and discontinuous transmission (DTX) cycles.

FIG. 6 depicts an example tracking reference signal (TRS) configuration.

FIG. 7 depicts an example slot allocation, in accordance with certain aspects of the present disclosure.

FIG. 8 depicts a call flow diagram, in accordance with certain aspects of the present disclosure.

FIGS. 9A and 9B depict example slot allocations, in accordance with certain aspects of the present disclosure.

FIGS. 10A and 10B depict example time domain lags, in accordance with certain aspects of the present disclosure.

FIGS. 11A and 11B depict physical downlink control channel (PDCCH) in example slot allocations, in accordance with certain aspects of the present disclosure.

FIGS. 12A and 12B depict two-stage PDCCH in example slot allocations, in accordance with certain aspects of the present disclosure.

FIG. 13 depicts an example channel state information (CSI) measurement configuration information element (IE), in accordance with certain aspects of the present disclosure.

FIG. 14 depicts a method for wireless communications.

FIG. 15 depicts a method for wireless communications.

FIG. 16 depicts aspects of an example communications device.

### DETAILED DESCRIPTION

Aspects of the present disclosure provide apparatuses, methods, processing systems, and computer-readable mediums for opportunistic transmission of reference signals (RSs).

In some scenarios, it may be beneficial to perform a type of channel state reporting that indicates time correlation of certain channel measurements at different points in time. Such time-domain channel properties (TDCP) reporting may be beneficial, for example, for user equipments (UEs) traveling at certain velocities, by exploiting time-domain correlation/Doppler-domain information to assist in determining optimal precoding for downlink transmissions.

In some cases, a UE may be configured to report TDCP based on channel state information reference signals (CSI-RS) used for tracking, referred to as tracking reference signals (TRS). TRS-based TDCP reporting may be based on time-domain correlation profile, for example, determined as a correlation within one TRS resource or a correlation across multiple TRS resources.

In some cases, a UE may be configured to report time correlation over one or more lags of TRS resource, where a lag refers to the time distance between measured TRS. The lags may be within one TRS (e.g., a TRS burst), between different TRS, and/or between a TRS and a different RS. When configured for multiple lags (multi-lag) time-correlation reporting, the UE may need to measure TRS and/or RS across multiple transmissions/bursts.

However, current resource saving and network energy savings (NES) techniques typically do not properly account for TDCP RS. For example, TRS without certain reporting configurations or with TDCP reporting configurations may have different behavior during cell discontinuous transmission (DTX), when a network is configured to refrain from transmitting to save power. Additionally, periodic and aperiodic RS may use different time references (e.g., absolute time based on system frame number SFN, periodicity, and/or offset) when compared to time reference based on DCI slot and trigger offset.

Further, in some wireless communication standards, periodic TRS configurations may only support periodicities (e.g., 10, 20, 40, 80 millisecond) that are not be appropriate for supporting certain lags. For example, using supported TRS periodicities, only certain types of lag values (e.g., 4 symbols, 1 slot) may be supported within a TRS.

Aspects of the present disclosure provide techniques provide techniques for utilizing resource sets of periodic RS resources for opportunistic transmission of RS. Certain time correlation metrics may be calculated based on measurement of periodically transmitted RS and opportunistically transmitted RS, which may enable improved TDCP reporting indicating the time correlation metric. Utilization of the techniques disclosed herein may result in flexible TDCP reporting, more optimal downlink precoding, improved resource savings and NES, better system performance, and improved overall user experience.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

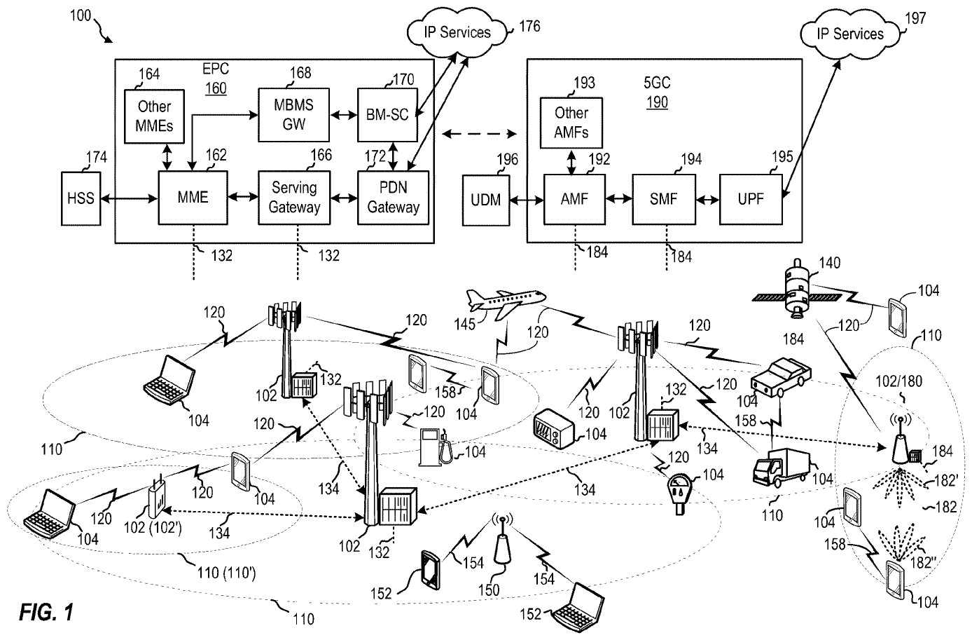

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IOT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

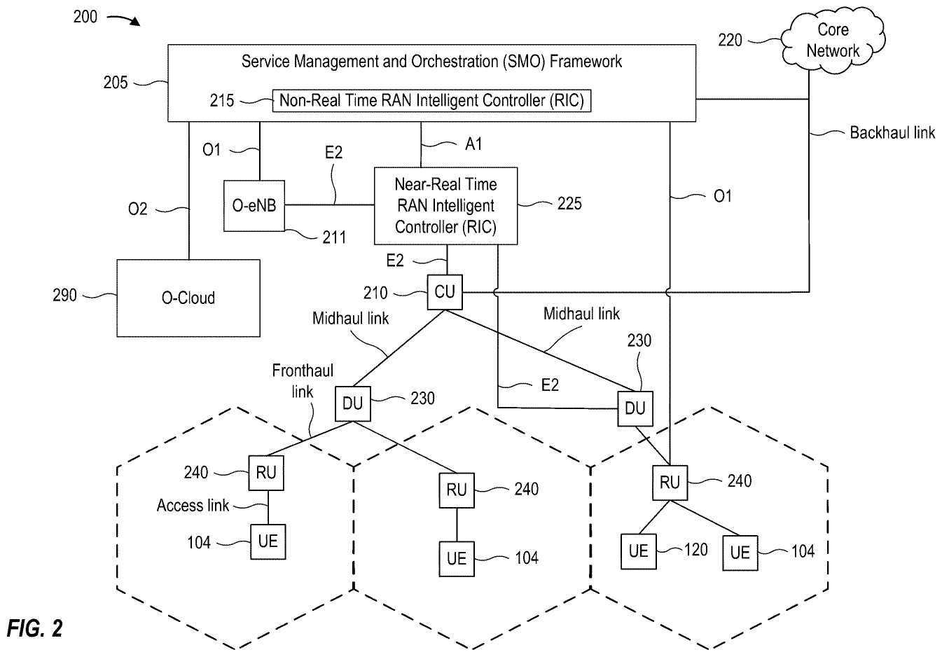

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUS), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-52,600 MHz, which is sometimes referred to (interchangeably) as a “millimeter wave” (“mmW” or “mmWave”). A base station configured to communicate using mmWave/near mm Wave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUS 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

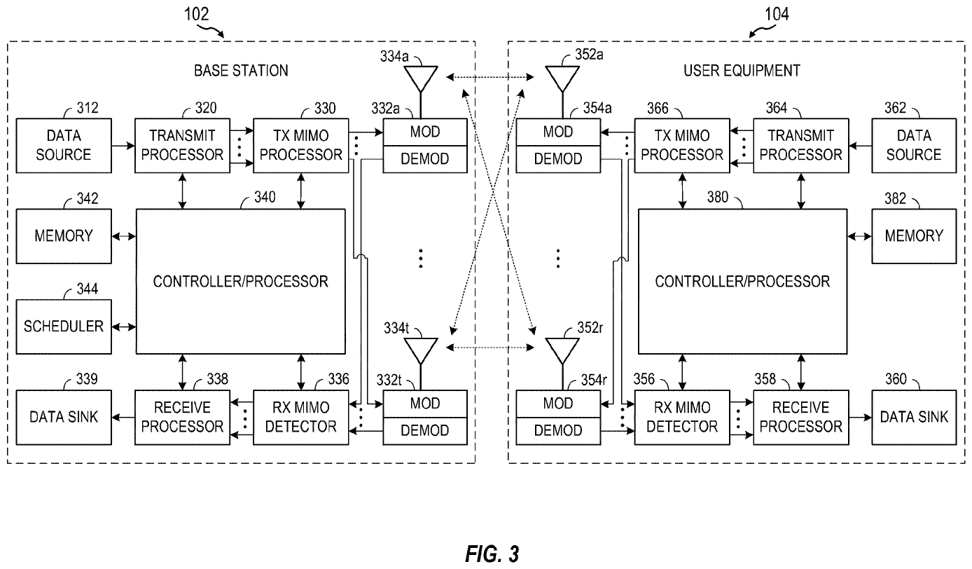

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

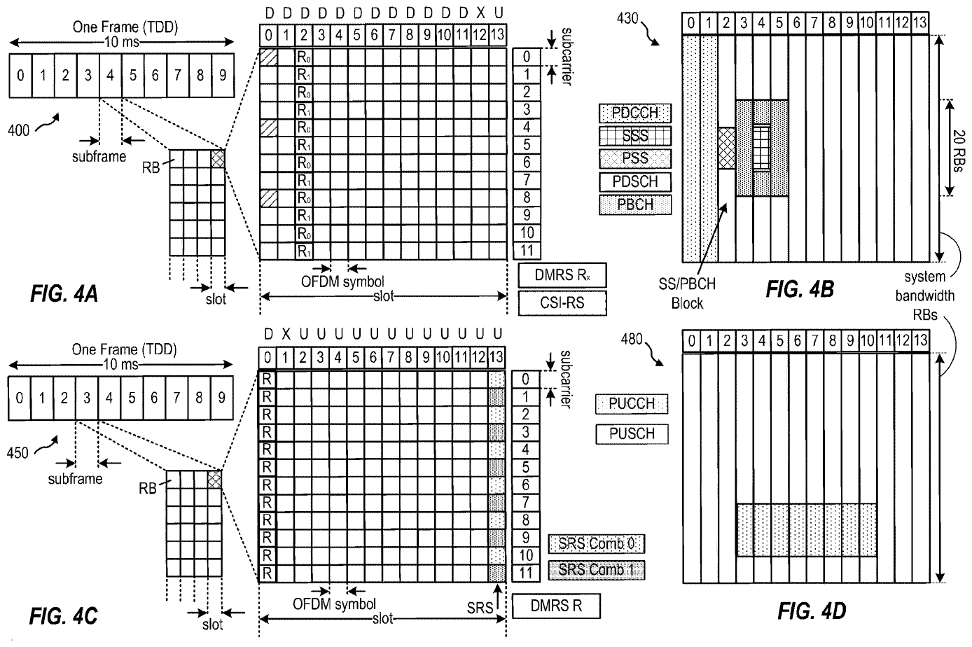

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology u, there are 14 symbols/slot and 2μ slots/subframe. The subcarrier spacing and symbol length/duration are a function of the numerology. The subcarrier spacing may be equal to 24× 15 kHz, where u is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### QCL Port and TCI States

In many cases, it is important for a UE to know which assumptions it can make on a channel corresponding to different transmissions. For example, the UE may need to know which reference signals it can use to estimate the channel in order to decode a transmitted signal (e.g., PDCCH or PDSCH). It may also be important for the UE to be able to report relevant channel state information (CSI) to the BS (gNB) for scheduling, link adaptation, and/or beam management purposes. In NR, the concept of quasi co-location (QCL) and transmission configuration indicator (TCI) states is used to convey information about these assumptions.

QCL assumptions are generally defined in terms of channel properties. Per 3GPP TS 38.214, “two antenna ports are said to be quasi-co-located if properties of the channel over which a symbol on one antenna port is conveyed can be inferred from the channel over which a symbol on the other antenna port is conveyed.” Different reference signals may be considered quasi co-located (“QCL′d”) if a receiver (e.g., a UE) can apply channel properties determined by detecting a first reference signal to help detect a second reference signal. TCI states generally include configurations such as QCL-relationships, for example, between the DL RSs in one CSI-RS set and the PDSCH DMRS ports.

In some cases, a UE may be configured with up to M TCI-States. Configuration of the M TCI-States can come about via higher layer signalling, while a UE may be signalled to decode PDSCH according to a detected PDCCH with DCI indicating one of the TCI states. Each configured TCI state may include one RS set TCI-RS-SetConfig that indicates different QCL assumptions between certain source and target signals.

For example, TCI-RS-SetConfig may indicate a source reference signal (RS) is indicated in the top block and is associated with a target signal indicated in the bottom block. In this context, a target signal generally refers to a signal for which channel properties may be inferred by measuring those channel properties for an associated source signal. As noted above, a UE may use the source RS to determine various channel parameters, depending on the associated QCL type, and use those various channel properties (determined based on the source RS) to process the target signal. A target RS does not necessarily need to be PDSCH's DMRS, rather it can be any other RS: PUSCH DMRS, CSIRS, TRS, and SRS.

Each TCI-RS-SetConfig may contain various parameters. These parameters can, for example, configure quasi co-location relationship(s) between reference signals in the RS set and the DM-RS port group of the PDSCH. The RS set contains a reference to either one or two DL RSs and an associated quasi co-location type (QCL-Type) for each one configured by the higher layer parameter QCL-Type.

For the case of two DL RSs, the QCL types can take on a variety of arrangements. For example, QCL types may not be the same, regardless of whether the references are to the same DL RS or different DL RSs. In the illustrated example, SSB is associated with Type C QCL for P-TRS, while CSI-RS for beam management (CSIRS-BM) is associated with Type D QCL.

QCL information and/or types may in some scenarios depend on or be a function of other information. For example, the quasi co-location (QCL) types indicated to the UE can be based on higher layer parameter QCL-Type and may take one or a combination of the following types:

QCL-TypeA: {Doppler shift, Doppler spread, average delay, delay
spread},
QCL-TypeB: {Doppler shift, Doppler spread},
QCL-TypeC: {average delay, Doppler shift}, and
QCL-TypeD: {Spatial Rx parameter},

Spatial QCL assumptions (QCL-TypeD) may be used to help a UE to select an analog Rx beam (e.g., during beam management procedures). For example, an SSB resource indicator may indicate a same beam for a previous reference signal should be used for a subsequent transmission.

An initial CORESET (e.g., CORESET ID 0 or simply CORESET #0) in NR may be identified during initial access by a UE (e.g., via a field in the MIB). A ControlResourceSet information element (CORESET IE) sent via radio resource control (RRC) signaling may convey information regarding a CORESET configured for a UE. The CORESET IE generally includes a CORESET ID, an indication of frequency domain resources (e.g., number of RBs) assigned to the CORESET, contiguous time duration of the CORESET in a number of symbols, and Transmission Configuration Indicator (TCI) states.

As noted above, a subset of the TCI states provide quasi co-location (QCL) relationships between DL RS(s) in one RS set (e.g., TCI-Set) and PDCCH demodulation RS (DMRS) ports. A particular TCI state for a given UE (e.g., for unicast PDCCH) may be conveyed to the UE by the Medium Access Control (MAC) Control Element (MAC-CE). The particular TCI state is generally selected from the set of TCI states conveyed by the CORESET IE, with the initial CORESET (CORESET #0) generally configured via MIB.

### Overview of Discontinuous Communication

As noted above, to reduce power consumption, a network entity (e.g., base station (BS) or gNB) or a UE may be configured for some type of cell discontinuous communications. For example, a UE may be configured for discontinuous reception (DRX) mode, during which the UE is may enter a low power state because it does not need to monitor for downlink transmissions. Similarly, in a discontinuous transmission (DTX) mode, a network may not transmit and may conserve power.

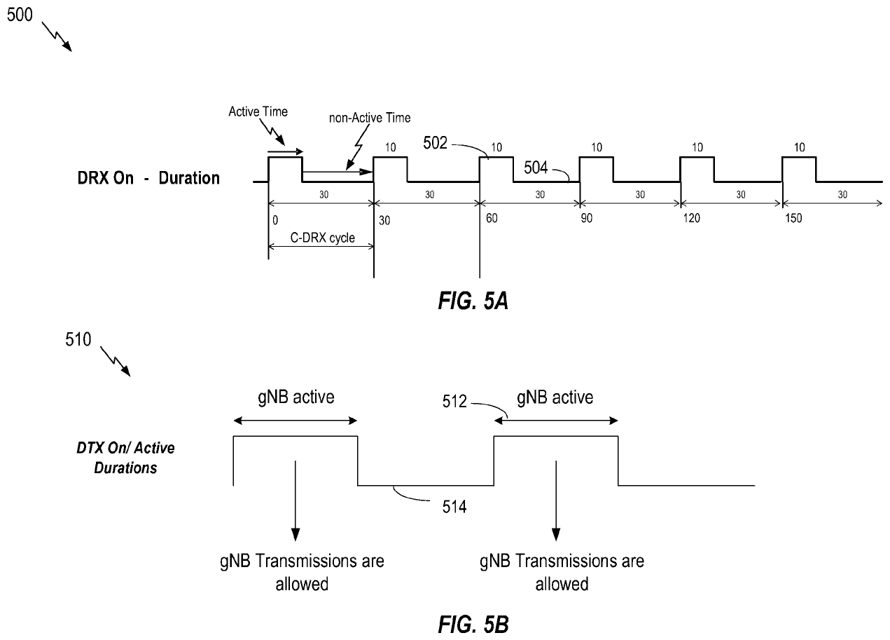

As illustrated in the timing diagram 500 of FIG. 5A, a UE in a DRX mode (e.g., a connected DRX mode or CDRX) can cycle/alternate between “Active time” durations 502 and “non-Active” time durations 504.

During a CDRX Active time (or On-Duration), the UE monitors for physical downlink shared channel (PDSCH) activity continuously or with a given periodicity, receives downlink data, transmits UL data, and/or makes serving cell measurements or neighbor measurements. During Active time, a UE is generally considered “on” while various timers are running. For example, an Active duration timer (e.g., drx-onDurationTimer), an inactivity timer (drx-InactivityTimer), and a complete DRX cycle duration (e.g., drx-ShortCycle) may run during an Active time. The beginning of a DRX cycle may be defined by a starting offset value.

In the examples, the Active time is 10 ms and the CDRX cycle duration is 30 ms. The UE may be configured with an inactivity timer (starting an inactivity period 506) that restarts when activity is detected and expires after 5 ms without detected activity. When the inactivity timer expires, the UE enters an “inactive” or “sleep” mode.

As illustrated in the timing diagram 510 of FIG. 5B, a network entity (e.g., a gNB) in a DTX mode can cycle/alternate between “ON/Active time” durations 512 and “OFF/non-Active” time durations 514.

While the gNB is active at 512, the gNB is allowed to send transmissions. When non-Active, the gNB does not need to transmit or receive certain periodic signals/channels, which may allow a network entity to conserve power. For example, when non-Active, the gNB may not need to transmit or receive common channels/signals or user equipment (UE) specific signals/channels, and may have no transmission/reception or only keep limited transmission/reception.

DTX may be configured to achieve energy savings at the network. DTX cycles can be configured semi-statically or dynamically, with a particular configuration typically determined with data communication as a goal.

### Overview of TRS Configuration

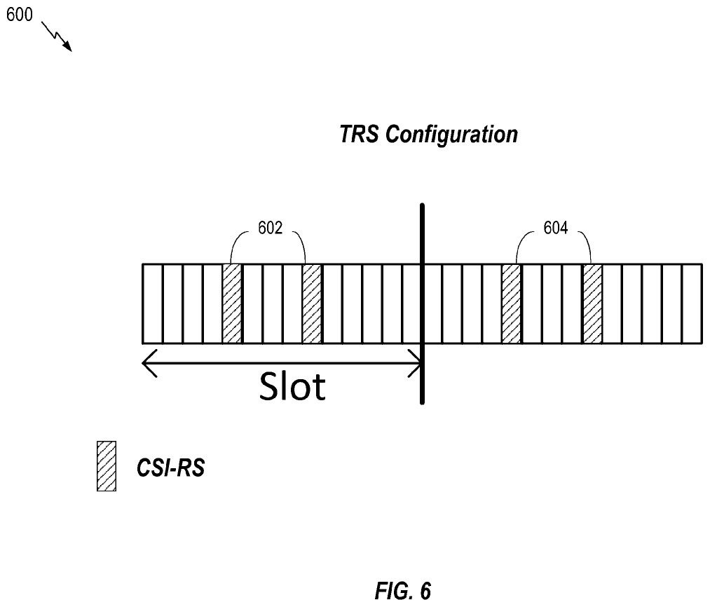

As illustrated in diagram 600 FIG. 6, a TRS (burst) may be configured as a CSI-RS resource set (configured with parameter trs-Info). The CSI-RS resource set may have 2 CSI-RS resources 602 in one slot, or 4 CSI-RS resources 604 in 2 consecutive slots (each slot with 2 CSI-RS resources).

Each of the CSI-RS resources may be single-port, and transmitted in the same bandwidth (BW) and on the same subcarriers/REs. Each CSI-RS resource may have a frequency domain (FD) density, for example, of 3 REs per RB.

Different types of TRS may be configured, including periodic TRS (P-TRS) and aperiodic TRS (AP-TRS). For P-TRS, all of the 2 or 4 CSI-RS resources within the set may have the same periodicity, bandwidth, and frequency location. An AP-TRS configuration should have a corresponding P-TRS with the same bandwidth and frequency location, and quasi co-located (QCLed) with ‘QCL-typeA’ or ‘QCL-typeD.’

In certain systems, TRS may be used only for DL tracking (up to UE implementation) and may not be relevant to CSI reporting. Thus, a UE may not expect to be configured with a CSI-ReportConfig with the higher layer parameter reportQuantity set to other than ‘none’ for aperiodic NZP CSI-RS resource set configured with trs-Info. Further, a UE may not expect to be configured with a CSI-ReportConfig for periodic NZP CSI-RS resource set configured with trs-Info.

### Aspects Related to Opportunistic Transmission of Periodic RSs

Aspects of the present disclosure provide apparatuses, methods, processing systems, and computer-readable mediums for opportunistic transmission of reference signals (RSs).

As noted above, in certain wireless communications standards, TRS is defined as a set of 4 single-port CSI-RS resources in 2 consecutive slots, or a set of 2 single-port CSI-RS resources in one single slot (e.g., which may be configured with a (‘true’ value of a) trs-Info parameter enabling tracking). In such wireless communication standards, periodic TRS only supports {10, 20, 40, 80} millisecond periodicities, which may not be appropriate for supporting some target delay (e.g., lag) values (e.g., {4 symbols, 1 slot, 2 slots, 3 slots, 4 slots, 5 slots, 6 slots, 10 slots}). For example, using the supported periodicities, only {4 symbols, 1 slot} may be supported within a TRS.

Aspects of the present disclosure provide techniques including having multiple CSI-RS resource sets configured for time-domain channel properties (TDCP) reporting, where an offset between two resource sets can be a targeted delay (lag). In some aspects, at least one CSI-RS resource set may be TRS, to leverage existing resources.

In order to save overhead, for example, resource Set #2 (or #3, #4, etc.) may have a longer periodicity than Set #1 (assuming TRS is Set #1). The longer periodicity of set #2 may be an integer multiple of the periodicity of Set #1, since TDCP may not need frequent updates.

In some aspects, resource set(s) other than Set #1 (TRS) may contain less CSI-RS resources (e.g. 2, or even 1) than TRS. In some aspects, Resource set(s) other than Set #1 (TRS) may not be defined as TRS. For example resource sets other than Set #1 may be set(s) of special single-port CSI-RS(s) with frequency density of 3 resource elements (REs) per resource block (RB).

In some cases, all CSI-RS resources of all sets for TDCP reporting may be QCLed (e.g., with QCL-TypeA and/or QCL-TypeD). Otherwise, autocorrelation may not be derivable based on the CSI-RS.

In some cases, periodic and/or semi-persistent CSI-RS may be configured in a CSI report configuration (e.g., CSI-ReportConfig) with a reportQuantity parameter including rank indicator (RI) for CSI reporting.

In some cases, different time references may be used for periodic and aperiodic RS. For example, periodic RS may use absolute time (e.g., system frame number, periodicity, offset, etc.) whereas aperiodic RS may use a downlink control information (DCI) slot and a trigger offset. This may lead to issues satisfying configured lags.

In certain wireless communications standards, some network energy savings (NES) considerations do not include TDCP RS. For example, TDCP reports may not contain RI (e.g., only CSI-RS reporting may include RI). Additionally, TRS without certain reporting configurations or with TDCP reporting configurations may have different UE/cell behavior during cell discontinuous transmission (DTX).

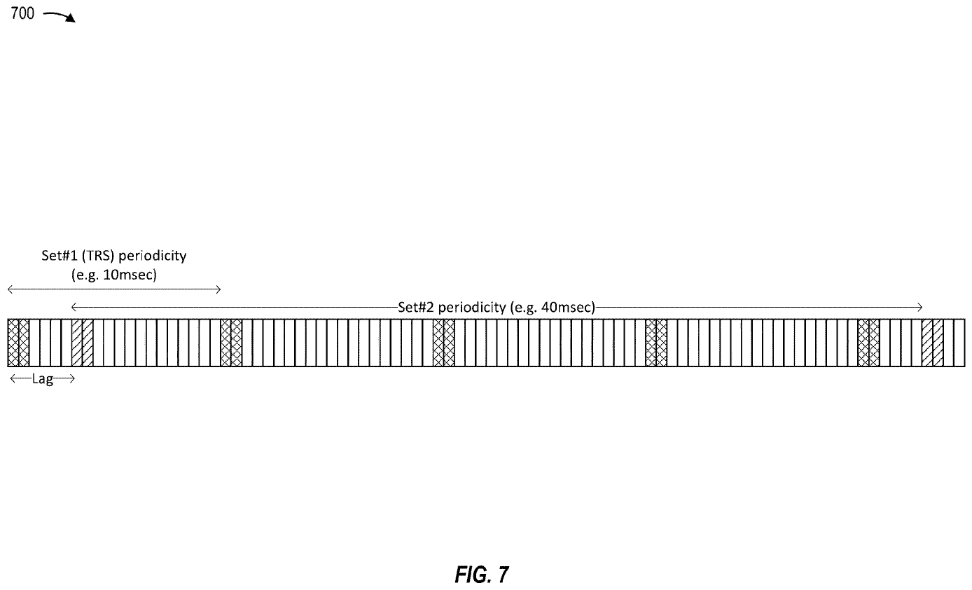

FIG. 7 depicts an example slot allocation 700 including two resource sets, in accordance with certain aspects of the present disclosure. As illustrated, for example, a first resource set (Set #1) associated with TRS may be configured with a certain periodicity (e.g., 10 milliseconds (ms)). As illustrated, a second resource set (Set #2) may be configured with a certain periodicity (e.g., 40 ms). As noted above, and as illustrated in this example, the periodicity of Set #2 may be an integer multiple of the periodicity of Set #1 (e.g., 10 ms*4=40 ms).

As illustrated, there may be an offset or targeted delay (e.g., lag) between the resource sets. In some aspects, a time correlation metric may be calculated based on the resource sets and/or the lag between the resource sets.

Aspects of the present disclosure provide techniques provide techniques for utilizing resource sets of periodic RS resources for opportunistic transmission of RS. Certain time correlation metrics may be calculated based on measurement of periodically transmitted RS and opportunistically transmitted RS, which may enable improved TDCP reporting indicating the time correlation metric.

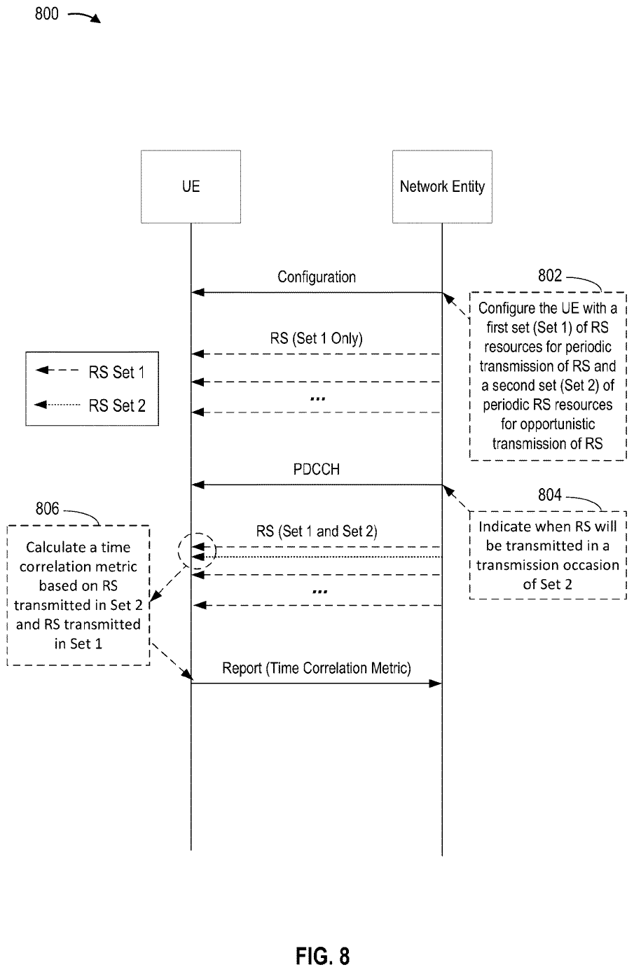

FIG. 8 depicts a call flow diagram 800 for opportunistic RS transmission for TDCP reporting, in accordance with certain aspects of the present disclosure.

In some aspects, the UE shown in FIG. 8 may be an example of the UE 104 depicted and described with respect to FIGS. 1 and 3. In some aspects, the network entity shown in FIG. 8 may be an example of the BS 102 (e.g., a gNB) depicted and described with respect to FIGS. 1 and 3 or a disaggregated base station depicted and described with respect to FIG. 2.

As illustrated at 802, a network entity may configure a UE with a first set (Set #1) of RS resources for periodic transmission of RS and at least a second set (Set #2) of periodic RS resources for opportunistic transmission of RS. For example, Set #1 and Set #2 may be configured with different periodicities as in the example shown in FIG. 7.

As illustrated, initially, RS may be transmitted in transmission occasions of Set #1 only. RS transmission on Set #2 may be referred to as opportunistic because they only occur under some conditions, unlike the (relatively certain) RS transmissions that occur each transmission occasion on Set #1. Set #1

As illustrated at 804, the network entity may transmit a PDCCH indicating when RS will be transmitted (opportunistically) in a transmission occasion of Set #2. As shown, for example, the network entity may transmit RS associated with Set #2 in accordance with the indication.

As illustrated at 806, the UE may calculate a time correlation metric based on RS transmitted in Set #2 and RS transmitted in Set #1. The UE may then transmit a report (e.g., a TDCP report), including the time correlation metric, to the network entity.

According to certain aspects of the present disclosure, for multiple (e.g., K>1) sets of periodic single-port CSI-RS resources configured for TDCP reporting (e.g., where Set #1 is TRS), at least one of the remaining K−1 set(s) may be opportunistically transmitted. For example, assuming RS is transmitted on Set #1 with some degree of certainty, RS may be transmitted on the remaining K−1 Sets (Sets 2−K) opportunistically.

According to a first option (Option 1), a UE may assume RS is not transmitted opportunistically unless triggered. For example where DTX is enabled default, the K−1 set(s) of resources may be transmitted based on dynamic triggering (e.g., a TDCP report triggering DCI). In other words, without at least one trigger event, the UE may assume that the K−1 set(s) are not transmitted (and does not need to monitor for RS in transmission occasions of these sets unless triggered).

According to a second option (Option 2), RS may be transmitted opportunistically by default on one or more sets. For example, where RS is transmitted on the K−1 set(s) of resources are transmitted by default, the K−1 set(s) of resources may not be transmitted based on cell DTX semi-static configuration or dynamic triggering (e.g., semi-static or dynamic “muting”). In other words, without a configuration or trigger event, the UE may assume that the K−1 sets are transmitted.

In either case, the potential occasions of the K−1 set(s) of resources may be determined by the delays (lags) configured with this TDCP report, as will be described in greater detail below. According to certain aspects, the remaining K−1 sets may each be configured with a (e.g., same) periodicity satisfying an integer (e.g., 1, 2, 4, 8) multiple of the periodicity of Set #1Set #1 TRS. In the example illustrated in FIG. 7, the periodicity of Set #2 is 40 ms, 4× the 10 ms periodicity of Set #1.

According to certain aspects, certain cell DTX behavior for TDCP RS other than Set #1 (e.g., TRS) may be applicable to Option 2 only (e.g., where the K−1 set(s) of resources are transmitted by default). For example, in some aspects, if cell DTX is semi-statically configured or dynamically triggered (e.g., within a cell-DTX non-active duration), other set(s) may not be transmitted (e.g., UE may assume network unavailability).

According to certain aspects, certain cell DTX behavior for Set #1 (TRS) configured with TDCP may be applicable to Option 2 and/or Option 1 (where DTX is the default). For example, in some aspects, if cell DTX is semi-statically configured or dynamically triggered (e.g., within a cell-DTX non-active duration), Set #1 (TRS) may not be transmitted. In other words, in this case, Set #1 (TRS) is also opportunistically transmitted. In such cases, the UE may assume network unavailability.

A third option (Option 3) may be considered a hybrid approach, for example, where of Option 1 and Option 2 work in a “layered” manner. For example, Option 2 may be used as a “muting-mask” for cell-DTX non-active duration (e.g., the first “layer”), and Option 1 may work on cell DRX, for the “non-muted” occasions (thus the second “layer”). In other words, in Option 3, Option 1 may define UE/cell behavior outside of a cell-DTX non-active duration.

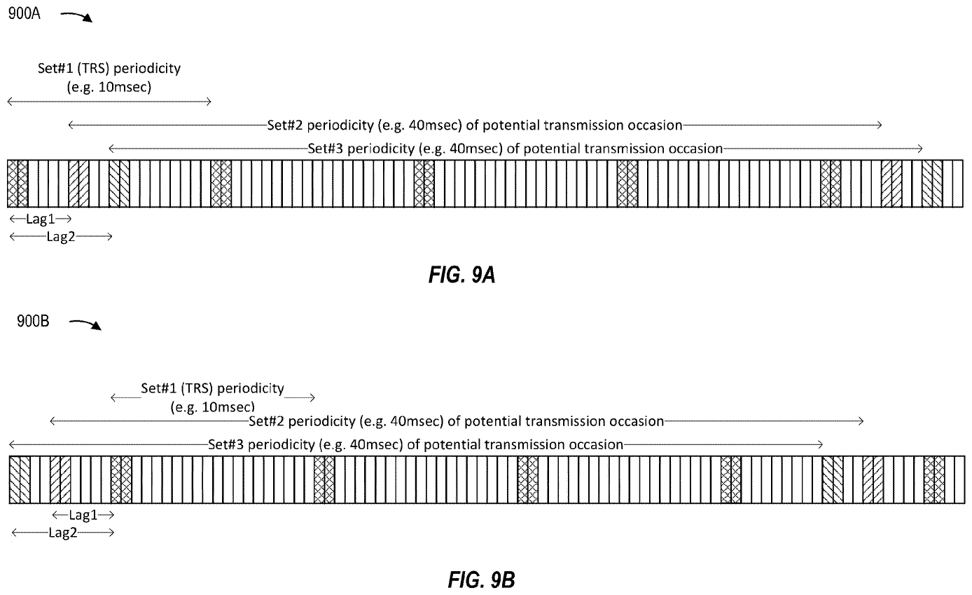

FIG. 9A depicts an example slot allocation 900A including 3 resource sets, that may allow for opportunistic RS transmission, in accordance with certain aspects of the present disclosure.

As illustrated in FIG. 9A, a first resource set (Set #1) associated with TRS may be configured with a certain periodicity (e.g., 10 ms). As illustrated, a second resource set (Set #2) may be configured with a certain periodicity (e.g., 40 ms) of potential transmission occasions (for opportunistic RS transmission). As illustrated, a third resource set (Set #3) may be configured with a certain periodicity (e.g., 40 ms) of potential transmission occasions.

As illustrated, there may be an offset or targeted delay (e.g., lag) between Set #1 and each of Set #2 and Set #3 (e.g., labeled as Lag1 and Lag2, respectively). In some aspects, a time correlation metric may be calculated based on one or more of the resource sets and/or at least one of these lags.

While FIG. 9A illustrates a scenario in an occasion of Set #1 is earlier than potential occasions of other K−1 set(s) (e.g., each of Set #2 and Set #3), FIG. 9B illustrates an alternative scenario 900B in which potential occasions of other K−1 set(s) (e.g., Set #2 and/or Set #3) may be earlier than an occasion of Set #1. For example, as illustrated in FIG. 9B, a potential occasion of Set #3 may occur before a potential occasion of Set #2, which may occur before an occasion of Set #1. As illustrated, in such a scenario, a lag may similarly be calculated based on an offset/targeted delay between Set #1 and each of Set #2 and Set #3 (e.g., labeled as Lag1 and Lag2 respectively).

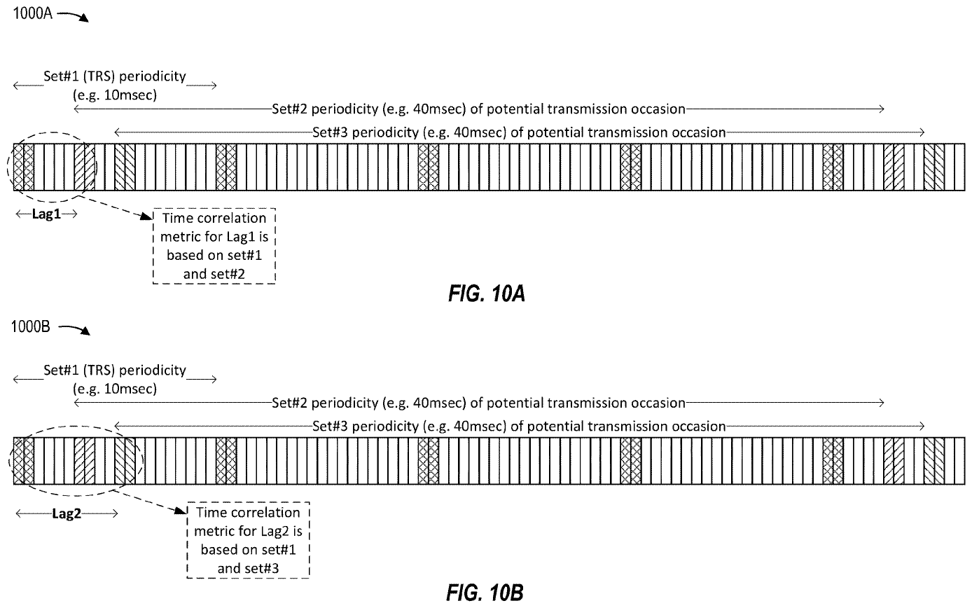

Opportunistic transmission for one of the sets may be triggered, depending on the particular lag for which TDCP reporting is desired. For example, as illustrated in diagram 1000A of FIG. 10A, Set #2 may be triggered in order for the UE to report a time correlation metric for Lag1. As illustrated in diagram 1000B of FIG. 10B, Set #3 may be triggered in order for the UE to report a time correlation metric for Lag2.

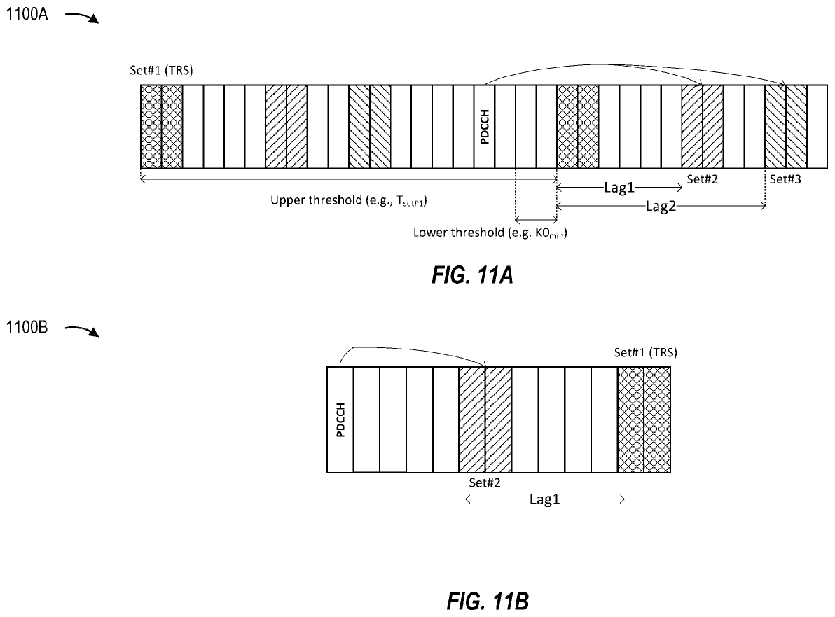

In some cases, opportunistic RS transmission may be triggered (indicated) via physical downlink control channel (PDCCH) transmission. For example, the timeline 1100A of FIG. 11A depicts a PDCCH that triggers opportunistic RS transmission, in accordance with certain aspects of the present disclosure.

In some aspects, a report triggering PDCCH (e.g., which could be an UL grant DCI) may be transmitted before one certain RS transmission occasion of Set #1 (e.g., TRS). As illustrated in FIG. 11A, for example, the PDCCH is transmitted at least a lower threshold value before a transmission occasion of Set #1, and the PDCCH triggers reporting for at least one of set #2 or set #3.

In some cases, behavior for TRS reception may be decided by the UE. For example, if the UE decides to receive the TRS occasions for DL tracking, it may be advantageous for the UE to have time to know/determine that additional efforts may be needed for the TDCP-related computation and report. If the UE decides not to receive the TRS occasions for DL tracking (e.g., if the UE determines that the reception is not necessary), it may be advantageous for it to still have time to prepare for the reception (e.g., switch on the DL RF chain, start DL buffering etc.).

According to certain aspects, a lower threshold gap may be needed for timing between PDCCH and the first RS used for TDCP reporting (e.g., PDCCH-to-Set #1). As illustrated in FIG. 11A, for example, this lower threshold can be based on K0ₘᵢₙ which may be defined as a minimum PDCCH-to-CSI-RS slot offset., K0ₘᵢₙ may typically apply to AP-CSI-RS, but in this context may apply to periodic TRS or periodic TDCP CSI-RS. In some cases, K0ₘᵢₙ may be defined for UE power savings.

According to certain aspects, an upper threshold gap may also be needed for PDCCH-to-Set #1. In some aspects, a lack of an upper threshold gap may cause ambiguity for periodic Set #1 (TRS) and/or which occasion the PDCCH is associated with. In other words, a UE may not know which RS to use for TDCP reporting. As illustrated in FIG. 11A, for example, this upper threshold can be determined by the periodicity of Set #1 (TRS). For example, in some aspects, the upper threshold may be based on a periodicity of Set #1. For example, the upper threshold may be equal to T_{Set #1} or T_{Set #1}+K0ₘᵢₙ.

In some aspects, as illustrated in example 1100B of FIG. 11B, a report triggering PDCCH may be used in a scenario where potential occasions of one or more of other K−1 set(s) (e.g., Set #2, and/or more) may be earlier than an occasion of Set #1. In some cases, this may be a set order requirement. In other words, the one or more of other K−1 set(s) occurring earlier than Set #1 TRS may be a requirement in some aspects.

In such cases, similarly to the scenario illustrated in FIG. 11A, a lower and/or upper threshold gap may be satisfied for PDCCH-to-Set #X. In some aspects, a lower threshold may similarly be based on K0ₘᵢₙ which generally applies to AP-CSI-RS, but here applies to opportunistic periodic TDCP CSI-RS). In some aspects, an upper threshold may be determined based on a periodicity of a given set (e.g., Set #2 or Set #3). For example, the upper threshold may be equal to T_{set #X} or T_{set #X}+K0ₘᵢₙ. In some aspects, Set #X (e.g, Set #2 or Set #3) may correspond the a largest delay (lag) configured for the TDCP report.

As noted above, in some cases, the slot where periodic CSI-RS is transmitted may be defined in an “absolute” manner by a system frame number (SFN) as:

$$( {N}_{slot}^{frame , μ} {n}_{f} + {n}_{s , f}^{μ} - {T}_{offset} ) mod {T}_{CSI - RS} ,$$

where

$${N}_{slot}^{frame , μ}$$

is a number of slots in a frame, such that, for {15, 30, 60, 120, 240} kHz Sub Carrier Spacing (SCS), for example,

$${N}_{slot}^{frame , μ} = \{ 10 , 20 , 40 , 80 , 1 \; 60 \} ;$$

$${n}_{s , f}^{μ}$$

is a set such that:

$${n}_{s , f}^{μ} ∈ \{ 0 , 1 , … , {N}_{slot}^{frame , μ} - 1 \}$$

n_{f} is the SFN, such that:

$${n}_{f} ∈ \{ 0 , 1 , … , 1023 \} ,$$

and
   T_{CSI-RS} and T_{offset} may be obtained from RRC parameter CSI-ResourcePeriodicityAndOffset.

In some aspects, periodicity and offset of different sets of resources may be denoted as: T_{set #1}, T_{set #other}, . . . and T_{offset #1}, T_{offset #2}, T_{offset #3}, . . . respectively.

In some aspects, for Set #1 (TRS) having a smallest periodicity, its every m-th periodicity (m∈{0, . . . , M−1}) may be denoted as T_{set #1} within the larger periodicity T_{set#other} associated with a TDCP report. In certain scenarios (e.g., the scenario illustrated in FIG. 11A):

$$m = ( X + M ) mod M , where$$

$$X ∈ \{ - 1 , 0 , … , M - 1 \} , satisfying$$

$${T}_{offset \#2} - ( {T}_{offset \#1} + X \cdot {T}_{set \#1} ) = {lag}_{1} .$$

In certain scenarios (e.g., the scenario illustrated in FIG. 11B):

$$m = X mod M , where$$

$$X ∈ \{ 0 , … , M \} satisfying$$

$${T}_{offset \#1} + X \cdot {T}_{set \#1} - {T}_{offset \#2} = {lag}_{1} .$$

In certain scenarios (e.g., the scenario illustrated in FIG. 11A), lag(s) may determine the potential occasions various sets (e.g., Set #2, Set #3 etc.) according to the following equations:

$${lag}_{1} = {T}_{offset ♯2} - {T}_{offset ♯1} - X \cdot {T}_{set \#1} ; and$$

$${l ag}_{2} = {T}_{offset ♯3} - {T}_{offset ♯1} - X \cdot {T}_{set \#1} ;$$

which may be generalized as:

$${lag}_{K - 1} = {T}_{offset ♯ K} - {T}_{offset ♯1} - X \cdot {T}_{set ♯1}$$

where K is the total number of resource sets for TDCP.

Alternatively, in certain scenarios (e.g., the scenario illustrated in FIG. 11B), the lag(s) may determine the potential occasions various sets (e.g., Set #2, Set #3 etc.) according to the following equations:

$${lag}_{1} = {T}_{offSet ♯1} + X \cdot {T}_{Set ♯1} - {T}_{offSet ♯2} ; and$$

$${l ag}_{2} = {T}_{offSet ♯1} + X \cdot {T}_{Set ♯1} - {T}_{offSet ♯3} ;$$

which may be generalized as:

$${lag}_{K - 1} = {T}_{offSet \#1} + X \cdot {T}_{Set ♯1} - {T}_{offset \# K} ;$$

where K is the total number of resource sets for TDCP.

In some cases, the delay (e.g., lag) may be too long (e.g., ≥10 slots) from triggering PDCCH to reporting PUSCH, even without accounting for a PDCCH-to-Set #1 gap and/or a CSI processing timeline (e.g., Z′ symbols).

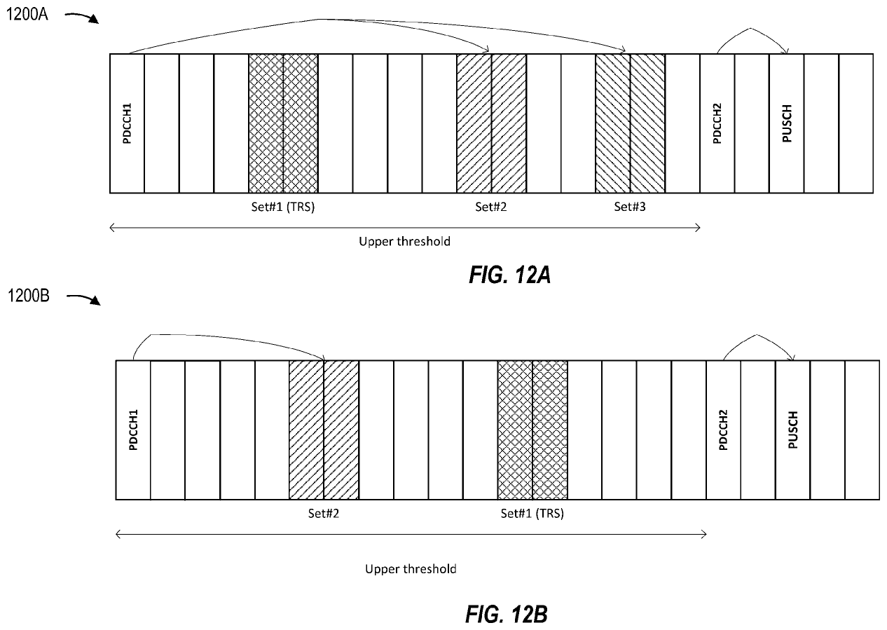

According to certain aspects of the present disclosure, a 2-stage PDCCH may be used as illustrated in diagram 1200A of FIG. 12A. For example, as illustrated, PDCCH1 may still be a UL grant (e.g., similar to the PDCCH described above with reference to FIGS. 11A/B), but may only trigger TDCP measurement and the transmission of a potential occasion of Set #2 (e.g., or Set #3, etc.). In other words, in some aspects for 2-stage PDCCH, PDCCH1 may not trigger TDCP reporting, as illustrated. In such cases, PDCCH1 may still schedule a PUSCH that is not a TDCP report (which is not illustrated in FIG. 12A).

According to certain aspects, PDCCH1 may still be transmitted before a certain occasion of Set #1, and may still require a lower threshold gap and/or an upper threshold gap as described above with reference to FIGS. 11A and/or 11B. In some aspects, PDCCH1 may satisfy one or more of the criteria (e.g., thresholds, ordering of potential occasions of sets, etc.) described above with reference to FIGS. 11A and/or 11B.

According to certain aspects, a second PDCCH (PDCCH2) may be used to trigger a PUSCH (e.g., another PUSCH) to convey the TDCP report. In some aspects, PDCCH2 and/or PDCCH1 may need to indicate a same AP-report triggering state.

In some aspects, as illustrated in FIG. 12A, a gap/distance from PDCCH1-to-PDCCH2 may need to be smaller than an (upper) threshold gap. Without such a gap/threshold PDCCH2 may be a new TDCP measurement triggering PDCCH1′.

In some aspects, as illustrated in diagram 1200B of FIG. 12B, a two stage DCI may be used in a scenario where potential occasions of one or more of other K−1 set(s) (e.g., Set #2 and/or more) may be earlier than an occasion of Set #1. In such scenarios, as illustrated, PDCCH1 may occur before Set #2, and may trigger TDCP measurement and the transmission of a potential occasion of Set #2. In such cases, PDCCH1 may still schedule a PUSCH that is not a TDCP report (which is not illustrated in FIG. 12B).

PDCCH2 may be used to trigger a PUSCH (e.g., another PUSCH) to convey the TDCP report. In some aspects, as illustrated in FIG. 12B, a gap/distance from PDCCH1-to-PDCCH2 may need to be smaller than an (upper) threshold gap.

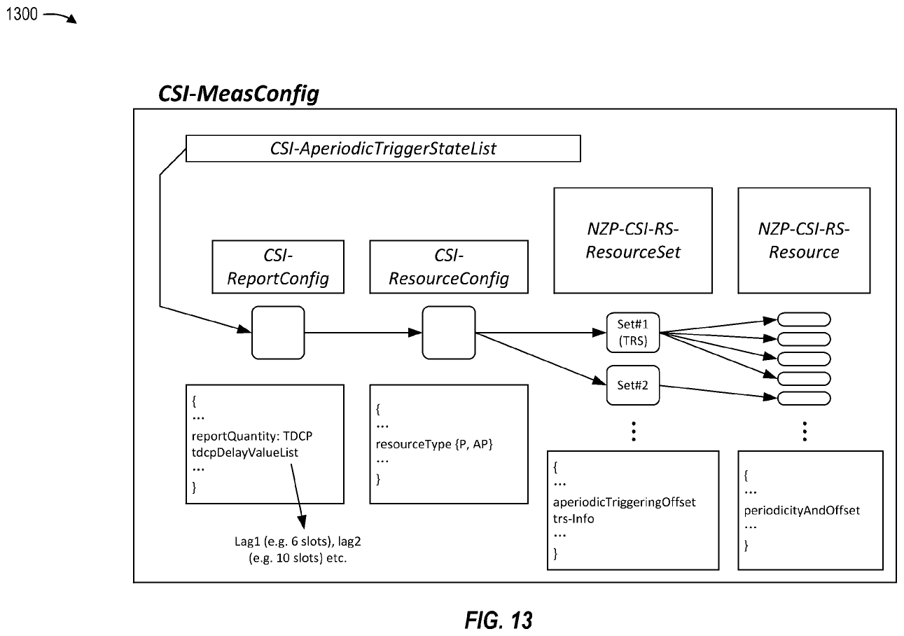

FIG. 13 depicts an example structure 1300 for channel state information (CSI) measurement configuration, in accordance with certain aspects of the present disclosure.

As illustrated, the CSI measurement configuration IE (CSI-MeasConfig) may include a CSI-AperiodicTriggerStateList IE, which may be used to configure the UE with a list of aperiodic trigger states. In some cases, each codepoint of a DCI field “CSI request” may be associated with one trigger state. Upon reception of the value associated with a trigger state, the UE may perform measurement of CSI-RS, CSI-IM and/or SSB (reference signals) and/or aperiodic reporting on LI according to all entries in an associatedReportConfigInfoList IE for that trigger state.

As illustrated, CSI-MeasConfig may include CSI reporting configuration (e.g., a CSI-ReportConfig field), which may include a reportQuantity parameter indicating CSI related quantities to report. The CSI-ReportConfig field may also include a tdcpDelayValueList field, which may define the various lag/delay durations (e.g., in terms of slots).

As illustrated in FIG. 13, CSI-MeasConfig may include a CSI resource configuration (e.g., CSI-ResourceConfig), which may indicate at least a resource type (e.g., periodic or aperiodic).

As illustrated in FIG. 13, CSI-MeasConfig may include various resource sets (e.g., in a NZP-CSI-RS-ResourceSet field), including one or more of Set #1, Set #2, Set #3, etc., as described above and may be involved in triggering measurement of RS transmitted in the various resource sets. For example, as noted above, a trs-Info parameter may be set to ‘true’ to configure Set #1. Additionally, as noted above, an aperiodicTriggeringOffset field may define an offset X between a slot containing the DCI that triggers a set of aperiodic NZP CSI-RS resources and a slot in which the CSI-RS resource set is transmitted. The value 0, for example, may correspond to 0 slots, a value of 1 may correspond to 1 slot, a value of 2 may correspond to 2 slots, etc. When the field is absent, the UE may apply the value 0.

As illustrated in FIG. 13, CSI-MeasConfig may include various resources (e.g., which make up the resource sets Set #1, Set #2, Set #3, etc.). These various resource may be defined, for example, in an NZP-CSI-RS-Resource field, which may include at least a field (e.g., a periodicityAndOffset field) defining periodicity and slot offsets (e.g., periodicities associated with the various resources/resource sets and offsets associated with the various lag/delay durations). A corresponding offset, for example, may be defined by a number of slots.

### Example Operations

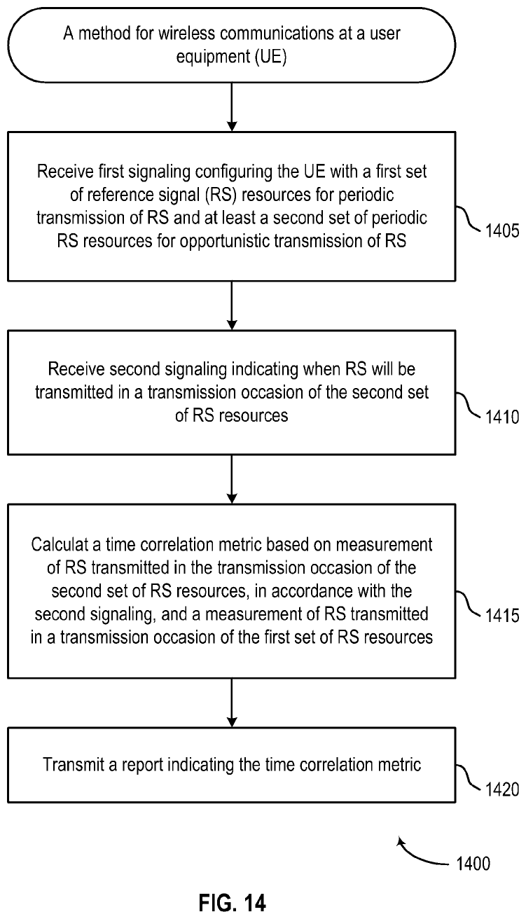

FIG. 14 shows an example of a method 1400 of wireless communications at a user equipment (UE), such as a UE 104 of FIGS. 1 and 3.

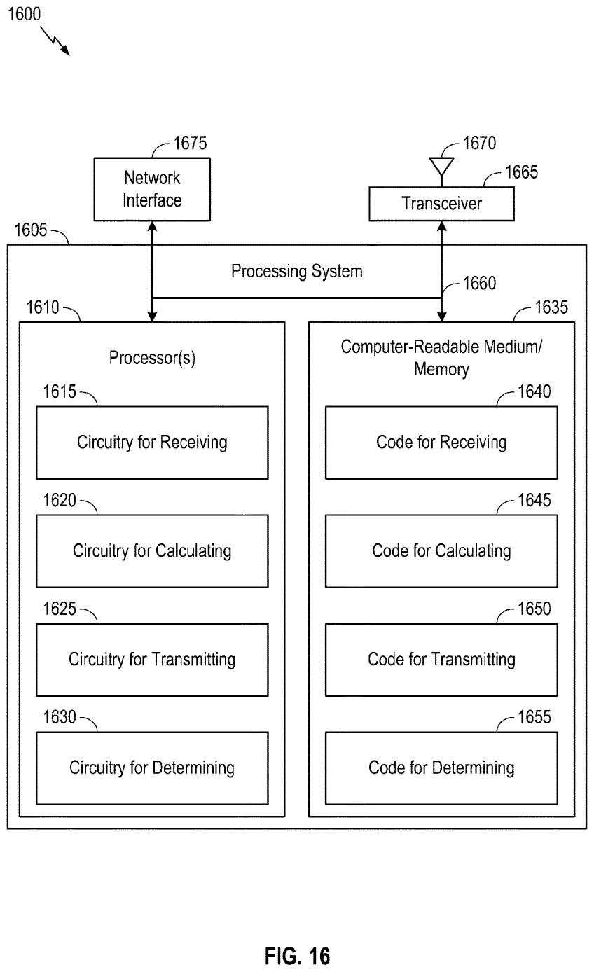

Method 1400 begins at step 1405 with receiving first signaling configuring the UE with a first set of reference signal (RS) resources for periodic transmission of RS and at least a second set of periodic RS resources for opportunistic transmission of RS. In some cases, the operations of this step refer to, or may be performed by, circuitry for receiving and/or code for receiving as described with reference to FIG. 16.

Method 1400 then proceeds to step 1410 with receiving second signaling indicating when RS will be transmitted in a transmission occasion of the second set of RS resources. In some cases, the operations of this step refer to, or may be performed by, circuitry for receiving and/or code for receiving as described with reference to FIG. 16.

Method 1400 then proceeds to step 1415 with calculating a time correlation metric based on measurement of RS transmitted in the transmission occasion of the second set of RS resources, in accordance with the second signaling, and a measurement of RS transmitted in a transmission occasion of the first set of RS resources. In some cases, the operations of this step refer to, or may be performed by, circuitry for calculating and/or code for calculating as described with reference to FIG. 16.

Method 1400 then proceeds to step 1420 with transmitting a report indicating the time correlation metric. In some cases, the operations of this step refer to, or may be performed by, circuitry for transmitting and/or code for transmitting as described with reference to FIG. 16.

In some aspects, the time correlation metric is for a lag that represents a separation in time between the transmission occasion of the first set of RS resources and the transmission occasion of the second set of RS resources.

In some aspects, the at least a second set of periodic RS resources comprises multiple sets of periodic RS resources; and a value of the lag determines the transmission occasion of one of the multiple sets of periodic RS resources.

In some aspects, the first set of RS resources is configured with a first periodicity; and each of the multiple sets of periodic RS resources is configured with a periodicity that is an integer multiple of the first periodicity.

In some aspects, the method 1400 further includes determining the transmission occasion of the second set of RS resources used to calculate the time correlation metric based on: the value of the lag, a first offset associated with the first set of RS resources, a second offset associated with the second set of periodic RS resources, and the first periodicity. In some cases, the operations of this step refer to, or may be performed by, circuitry for determining and/or code for determining as described with reference to FIG. 16.

In some aspects, the second signaling comprises a first physical downlink control channel (PDCCH) that triggers reporting time correlation.

In some aspects, the UE is configured to calculate the time correlation metric only if the PDCCH satisfies a timing requirement based on an offset between the PDCCH and the transmission occasion of the first set of RS resources.

In some aspects, the timing requirement dictates that the offset be at least one of: not less than a first threshold; and not greater than a second threshold, wherein the second threshold that is greater than the first threshold.

In some aspects, the method 1400 further includes receiving a second PDCCH that triggers transmitting the report. In some cases, the operations of this step refer to, or may be performed by, circuitry for receiving and/or code for receiving as described with reference to FIG. 16.

In some aspects, the first PDCCH and second PDCCH indicate a same aperiodic report triggering state.

In some aspects, an offset between the first PDCCH and the second PDCCH is less than or equal to a threshold value.

In some aspects, the transmission occasion of the second set of RS resources is associated with a largest value of lag.

In some aspects, RS is not transmitted in transmission occasions of the second set of RS resources during non-active network discontinuous transmission (DTX) durations; and the second signaling indicates an active network DTX duration.

In some aspects, RS is not transmitted in transmission occasions of the first set of RS resources during non-active network DTX durations.

In some aspects, RS is not transmitted in transmission occasions of the second set of RS resources during non-active network discontinuous transmission (DTX) durations; and the second signaling comprises a physical downlink control channel (PDCCH) that indicates RS will be transmitted in a transmission occasion of the second set of RS resources during active network DTX durations.

In one aspect, method 1400, or any aspect related to it, may be performed by an apparatus, such as communications device 1600 of FIG. 16, which includes various components operable, configured, or adapted to perform the method 1400. Communications device 1600 is described below in further detail.

Note that FIG. 14 is just one example of a method, and other methods including fewer, additional, or alternative steps are possible consistent with this disclosure.

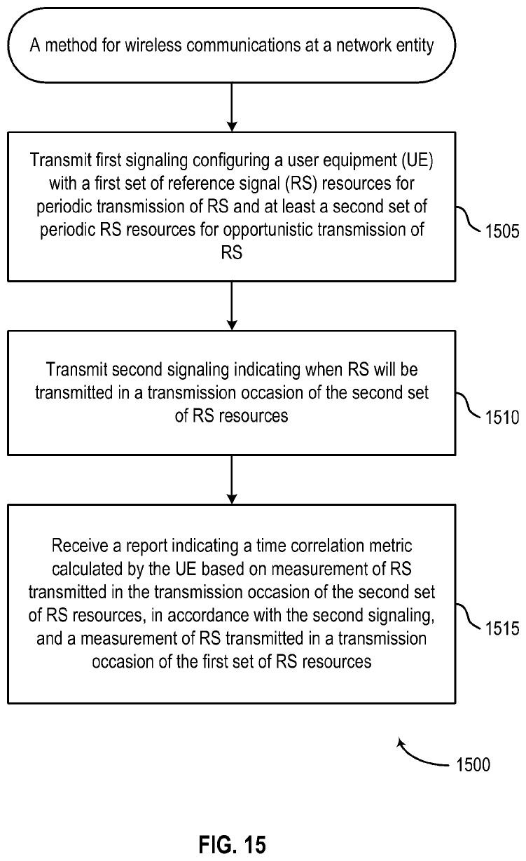

FIG. 15 shows an example of a method 1500 of wireless communications at a network entity, such as a BS 102 of FIGS. 1 and 3, or a disaggregated base station as discussed with respect to FIG. 2.

Method 1500 begins at step 1505 with transmitting first signaling configuring a user equipment (UE) with a first set of reference signal (RS) resources for periodic transmission of RS and at least a second set of periodic RS resources for opportunistic transmission of RS. In some cases, the operations of this step refer to, or may be performed by, circuitry for transmitting and/or code for transmitting as described with reference to FIG. 16.

Method 1500 then proceeds to step 1510 with transmitting second signaling indicating when RS will be transmitted in a transmission occasion of the second set of RS resources. In some cases, the operations of this step refer to, or may be performed by, circuitry for transmitting and/or code for transmitting as described with reference to FIG. 16.

Method 1500 then proceeds to step 1515 with receiving a report indicating a time correlation metric calculated by the UE based on measurement of RS transmitted in the transmission occasion of the second set of RS resources, in accordance with the second signaling, and a measurement of RS transmitted in a transmission occasion of the first set of RS resources. In some cases, the operations of this step refer to, or may be performed by, circuitry for receiving and/or code for receiving as described with reference to FIG. 16.

In some aspects, the time correlation metric is for a lag that represents a separation in time between the transmission occasion of the first set of RS resources and the transmission occasion of the second set of RS resources.

In some aspects, the at least a second set of periodic RS resources comprises multiple sets of periodic RS resources; and a value of the lag determines the transmission occasion of one of the multiple sets of periodic RS resources.

In some aspects, the transmission occasion of the second set of RS resources is associated with a largest value of lag

In some aspects, the first set of RS resources is configured with a first periodicity; and each of the multiple sets of periodic RS resources is configured with a periodicity that is an integer multiple of the first periodicity.

In some aspects, the method 1500 further includes determining the transmission occasion of the second set of RS resources used to calculate the time correlation metric based on: the value of the lag, a first offset associated with the first set of RS resources, a second offset associated with the second set of periodic RS resources, and the first periodicity. In some cases, the operations of this step refer to, or may be performed by, circuitry for determining and/or code for determining as described with reference to FIG. 16.

In some aspects, the second signaling comprises a first physical downlink control channel (PDCCH) that triggers reporting time correlation.

In some aspects, the UE is configured to calculate the time correlation metric only if the PDCCH satisfies a timing requirement based on an offset between the PDCCH and the transmission occasion of the first set of RS resources.

In some aspects, the timing requirement dictates that the offset be at least one of: not less than a first threshold; and not greater than a second threshold, wherein the second threshold that is greater than the first threshold.

In some aspects, the method 1500 further includes transmitting a second PDCCH that triggers transmitting the report. In some cases, the operations of this step refer to, or may be performed by, circuitry for transmitting and/or code for transmitting as described with reference to FIG. 16.

In some aspects, the first PDCCH and second PDCCH indicate a same aperiodic report triggering state.

In some aspects, an offset between the first PDCCH and the second PDCCH is less than or equal to a threshold value.

In some aspects, RS is not transmitted in transmission occasions of the second set of RS resources during non-active network discontinuous transmission (DTX) durations; and the second signaling indicates an active network DTX duration.

In some aspects, RS is not transmitted in transmission occasions of the first set of RS resources during non-active network DTX durations.

In some aspects, RS is not transmitted in transmission occasions of the second set of RS resources during non-active network discontinuous transmission (DTX) durations; and the second signaling comprises a physical downlink control channel (PDCCH) that indicates RS will be transmitted in a transmission occasion of the second set of RS resources during active network DTX durations.

In one aspect, method 1500, or any aspect related to it, may be performed by an apparatus, such as communications device 1600 of FIG. 16, which includes various components operable, configured, or adapted to perform the method 1500. Communications device 1600 is described below in further detail.

Note that FIG. 15 is just one example of a method, and other methods including fewer, additional, or alternative steps are possible consistent with this disclosure.

### Example Communications Device(s)

FIG. 16 depicts aspects of an example communications device 1600. In some aspects, communications device 1600 is a user equipment, such as UE 104 described above with respect to FIGS. 1 and 3. In some aspects, communications device 1600 is a network entity, such as BS 102 of FIGS. 1 and 3, or a disaggregated base station as discussed with respect to FIG. 2.

The communications device 1600 includes a processing system 1605 coupled to the transceiver 1665 (e.g., a transmitter and/or a receiver). In some aspects (e.g., when communications device 1600 is a network entity), processing system 1605 may be coupled to a network interface 1675 that is configured to obtain and send signals for the communications device 1600 via communication link(s), such as a backhaul link, midhaul link, and/or fronthaul link as described herein, such as with respect to FIG. 2. The transceiver 1665 is configured to transmit and receive signals for the communications device 1600 via the antenna 1670, such as the various signals as described herein. The processing system 1605 may be configured to perform processing functions for the communications device 1600, including processing signals received and/or to be transmitted by the communications device 1600.

The processing system 1605 includes one or more processors 1610. In various aspects, the one or more processors 1610 may be representative of one or more of receive processor 358, transmit processor 364, TX MIMO processor 366, and/or controller/processor 380, as described with respect to FIG. 3. In various aspects, one or more processors 1610 may be representative of one or more of receive processor 338, transmit processor 320, TX MIMO processor 330, and/or controller/processor 340, as described with respect to FIG. 3. The one or more processors 1610 are coupled to a computer-readable medium/memory 1635 via a bus 1660. In certain aspects, the computer-readable medium/memory 1635 is configured to store instructions (e.g., computer-executable code) that when executed by the one or more processors 1610, cause the one or more processors 1610 to perform the method 1400 described with respect to FIG. 14, or any aspect related to it; and the method 1500 described with respect to FIG. 15, or any aspect related to it. Note that reference to a processor performing a function of communications device 1600 may include one or more processors 1610 performing that function of communications device 1600.

In the depicted example, computer-readable medium/memory 1635 stores code (e.g., executable instructions), such as code for receiving 1640, code for calculating 1645, code for transmitting 1650, and code for determining 1655. Processing of the code for receiving 1640, code for calculating 1645, code for transmitting 1650, and code for determining 1655 may cause the communications device 1600 to perform the method 1400 described with respect to FIG. 14, or any aspect related to it; and the method 1500 described with respect to FIG. 15, or any aspect related to it.

The one or more processors 1610 include circuitry configured to implement (e.g., execute) the code stored in the computer-readable medium/memory 1635, including circuitry for receiving 1615, circuitry for calculating 1620, circuitry for transmitting 1625, and circuitry for determining 1630. Processing with circuitry for receiving 1615, circuitry for calculating 1620, circuitry for transmitting 1625, and circuitry for determining 1630 may cause the communications device 1600 to perform the method 1400 described with respect to FIG. 14, or any aspect related to it; and the method 1500 described with respect to FIG. 15, or any aspect related to it.

Various components of the communications device 1600 may provide means for performing the method 1400 described with respect to FIG. 14, or any aspect related to it; and the method 1500 described with respect to FIG. 15, or any aspect related to it. For example, means for transmitting, sending or outputting for transmission may include transceivers 354 and/or antenna(s) 352 of the UE 104 illustrated in FIG. 3, transceivers 332 and/or antenna(s) 334 of the BS 102 illustrated in FIG. 3, and/or the transceiver 1665 and the antenna 1670 of the communications device 1600 in FIG. 16. Means for receiving or obtaining may include transceivers 354 and/or antenna(s) 352 of the UE 104 illustrated in FIG. 3, transceivers 332 and/or antenna(s) 334 of the BS 102 illustrated in FIG. 3, and/or the transceiver 1665 and the antenna 1670 of the communications device 1600 in FIG. 16.

### Example Clauses

Implementation examples are described in the following numbered clauses:
Clause 1: A method for wireless communications at a user equipment (UE), comprising: receiving first signaling configuring the UE with a first set of reference signal (RS) resources for periodic transmission of RS and at least a second set of periodic RS resources for opportunistic transmission of RS; receiving second signaling indicating when RS will be transmitted in a transmission occasion of the second set of RS resources; calculating a time correlation metric based on measurement of RS transmitted in the transmission occasion of the second set of RS resources, in accordance with the second signaling, and a measurement of RS transmitted in a transmission occasion of the first set of RS resources; and transmitting a report indicating the time correlation metric.
Clause 2: The method of Clause 1, wherein the time correlation metric is for a lag that represents a separation in time between the transmission occasion of the first set of RS resources and the transmission occasion of the second set of RS resources.
Clause 3: The method of Clause 2, wherein: the at least a second set of periodic RS resources comprises multiple sets of periodic RS resources; and a value of the lag determines the transmission occasion of one of the multiple sets of periodic RS resources.
Clause 4: The method of Clause 3, wherein: the first set of RS resources is configured with a first periodicity; and each of the multiple sets of periodic RS resources is configured with a periodicity that is an integer multiple of the first periodicity.
Clause 5: The method of Clause 4, further comprising determining the transmission occasion of the second set of RS resources used to calculate the time correlation metric based on: the value of the lag, a first offset associated with the first set of RS resources, a second offset associated with the second set of periodic RS resources, and the first periodicity.
Clause 6: The method of any one of Clauses 1-5, wherein the second signaling comprises a first physical downlink control channel (PDCCH) that triggers reporting time correlation.
Clause 7: The method of Clause 6, wherein the UE is configured to calculate the time correlation metric only if the PDCCH satisfies a timing requirement based on an offset between the PDCCH and the transmission occasion of the first set of RS resources.
Clause 8: The method of Clause 7, wherein the timing requirement dictates that the offset be at least one of: not less than a first threshold; and not greater than a second threshold, wherein the second threshold that is greater than the first threshold.
Clause 9: The method of Clause 6, further comprising receiving a second PDCCH that triggers transmitting the report.
Clause 10: The method of Clause 9, wherein the first PDCCH and second PDCCH indicate a same aperiodic report triggering state.
Clause 11: The method of Clause 9, wherein an offset between the first PDCCH and the second PDCCH is less than or equal to a threshold value.
Clause 12: The method of any one of Clauses 1-11, wherein: RS is not transmitted in transmission occasions of the second set of RS resources during non-active network discontinuous transmission (DTX) durations; and the second signaling indicates an active network DTX duration.
Clause 13: The method of Clause 12, wherein RS is not transmitted in transmission occasions of the first set of RS resources during non-active network DTX durations.
Clause 14: The method of any one of Clauses 1-13, wherein: RS is not transmitted in transmission occasions of the second set of RS resources during non-active network discontinuous transmission (DTX) durations; and the second signaling comprises a physical downlink control channel (PDCCH) that indicates RS will be transmitted in a transmission occasion of the second set of RS resources during active network DTX durations.
Clause 15: A method for wireless communications at a network entity, comprising: transmitting first signaling configuring a user equipment (UE) with a first set of reference signal (RS) resources for periodic transmission of RS and at least a second set of periodic RS resources for opportunistic transmission of RS; transmitting second signaling indicating when RS will be transmitted in a transmission occasion of the second set of RS resources; and receiving a report indicating a time correlation metric calculated by the UE based on measurement of RS transmitted in the transmission occasion of the second set of RS resources, in accordance with the second signaling, and a measurement of RS transmitted in a transmission occasion of the first set of RS resources.
Clause 16: The method of Clause 15, wherein the time correlation metric is for a lag that represents a separation in time between the transmission occasion of the first set of RS resources and the transmission occasion of the second set of RS resources.
Clause 17: The method of Clause 16, wherein: the at least a second set of periodic RS resources comprises multiple sets of periodic RS resources; and a value of the lag determines the transmission occasion of one of the multiple sets of periodic RS resources.
Clause 18: The method of Clause 17, wherein: the first set of RS resources is configured with a first periodicity; and each of the multiple sets of periodic RS resources is configured with a periodicity that is an integer multiple of the first periodicity.
Clause 19: The method of Clause 18, further comprising determining the transmission occasion of the second set of RS resources used to calculate the time correlation metric based on: the value of the lag, a first offset associated with the first set of RS resources, a second offset associated with the second set of periodic RS resources, and the first periodicity.
Clause 20: The method of any one of Clauses 15-19, wherein the second signaling comprises a first physical downlink control channel (PDCCH) that triggers reporting time correlation.
Clause 21: The method of Clause 20, wherein the UE is configured to calculate the time correlation metric only if the PDCCH satisfies a timing requirement based on an offset between the PDCCH and the transmission occasion of the first set of RS resources.
Clause 22: The method of Clause 21, wherein the timing requirement dictates that the offset be at least one of: not less than a first threshold; and not greater than a second threshold, wherein the second threshold that is greater than the first threshold.
Clause 23: The method of Clause 20, further comprising transmitting a second PDCCH that triggers transmitting the report.
Clause 24: The method of Clause 23, wherein the first PDCCH and second PDCCH indicate a same aperiodic report triggering state.
Clause 25: The method of Clause 23, wherein an offset between the first PDCCH and the second PDCCH is less than or equal to a threshold value.
Clause 26: The method of any one of Clauses 15-25, wherein: RS is not transmitted in transmission occasions of the second set of RS resources during non-active network discontinuous transmission (DTX) durations; and the second signaling indicates an active network DTX duration.
Clause 27: The method of Clause 26, wherein RS is not transmitted in transmission occasions of the first set of RS resources during non-active network DTX durations.
Clause 28: The method of any one of Clauses 15-27, wherein: RS is not transmitted in transmission occasions of the second set of RS resources during non-active network discontinuous transmission (DTX) durations; and the second signaling comprises a physical downlink control channel (PDCCH) that indicates RS will be transmitted in a transmission occasion of the second set of RS resources during active network DTX durations.
Clause 29: An apparatus, comprising: a memory comprising executable instructions; and a processor configured to execute the executable instructions and cause the apparatus to perform a method in accordance with any one of Clauses 1-28.
Clause 30: An apparatus, comprising means for performing a method in accordance with any one of Clauses 1-28.
Clause 31: A non-transitory computer-readable medium comprising executable instructions that, when executed by a processor of an apparatus, cause the apparatus to perform a method in accordance with any one of Clauses 1-28.
Clause 32: A computer program product embodied on a computer-readable storage medium comprising code for performing a method in accordance with any one of Clauses 1-28.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, “a processor,” “at least one processor” or “one or more processors” generally refers to a single processor configured to perform one or multiple operations or multiple processors configured to collectively perform one or more operations. In the case of multiple processors, performance the one or more operations could be divided amongst different processors, though one processor may perform multiple operations, and multiple processors could collectively perform a single operation. Similarly, “a memory,” “at least one memory” or “one or more memories” generally refers to a single memory configured to store data and/or instructions, multiple memories configured to collectively store data and/or instructions.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. An apparatus for wireless communications at a user equipment (UE), comprising: a memory comprising computer-executable instructions; and one or more processors configured to execute the computer-executable instructions and cause the apparatus to:
receive first signaling configuring the UE with a first set of reference signal (RS) resources for periodic transmission of RS and at least a second set of periodic RS resources for opportunistic transmission of RS;
receive second signaling indicating when RS will be transmitted in a transmission occasion of the second set of RS resources;
calculate a time correlation metric based on measurement of RS transmitted in the transmission occasion of the second set of RS resources, in accordance with the second signaling, and a measurement of RS transmitted in a transmission occasion of the first set of RS resources; and
transmit a report indicating the time correlation metric.

2. The apparatus of claim 1, wherein the time correlation metric is for a lag that represents a separation in time between the transmission occasion of the first set of RS resources and the transmission occasion of the second set of RS resources.

3. The apparatus of claim 2, wherein:
the at least a second set of periodic RS resources comprises multiple sets of periodic RS resources; and
a value of the lag determines the transmission occasion of one of the multiple sets of periodic RS resources.

4. The apparatus of claim 3, wherein:
the first set of RS resources is configured with a first periodicity; and
each of the multiple sets of periodic RS resources is configured with a periodicity that is an integer multiple of the first periodicity.

5. The apparatus of claim 4, wherein the one or more processors are further configured to execute the computer-executable instructions and cause the apparatus to:
determine the transmission occasion of the second set of RS resources used to calculate the time correlation metric based, at least in part, on: the value of the lag, a first offset associated with the first set of RS resources, a second offset associated with the second set of periodic RS resources, and the first periodicity.

6. The apparatus of claim 1, wherein the second signaling comprises a first physical downlink control channel (PDCCH) that triggers reporting time correlation.

7. The apparatus of claim 6, wherein the UE is configured to calculate the time correlation metric only if the PDCCH satisfies a timing requirement based on at least one of a first offset between the PDCCH and the transmission occasion of the first set of RS resources or a second offset between the PDCCH and the transmission occasion of the second set of RS resources.

8. The apparatus of claim 7, wherein the transmission occasion of the second set of RS resources is associated with a largest value of lag.

9. The apparatus of claim 7, wherein the timing requirement dictates that the first offset be at least one of: not less than a first threshold; and not greater than a second threshold, wherein the second threshold that is greater than the first threshold.

10. The apparatus of claim 6, wherein the one or more processors are further configured to execute the computer-executable instructions and cause the apparatus to:
receive a second PDCCH that triggers transmitting the report.

11. The apparatus of claim 10, wherein the first PDCCH and second PDCCH indicate a same aperiodic report triggering state.

12. The apparatus of claim 10, wherein an offset between the first PDCCH and the second PDCCH is less than or equal to a threshold value.

13. The apparatus of claim 1, wherein:
RS is not transmitted in transmission occasions of the second set of RS resources during non-active network discontinuous transmission (DTX) durations;
the second signaling indicates an active network DTX duration; and
RS is not transmitted in transmission occasions of the first set of RS resources during non-active network DTX durations.

14. The apparatus of claim 1, wherein:
RS is not transmitted in transmission occasions of the second set of RS resources during non-active network discontinuous transmission (DTX) durations; and
the second signaling comprises a physical downlink control channel (PDCCH) that indicates RS will be transmitted in a transmission occasion of the second set of RS resources during active network DTX durations.

15. An apparatus for wireless communications at a network entity, comprising: a memory comprising computer-executable instructions; and one or more processors configured to execute the computer-executable instructions and cause the apparatus to:
transmit first signaling configuring a user equipment (UE) with a first set of reference signal (RS) resources for periodic transmission of RS and at least a second set of periodic RS resources for opportunistic transmission of RS;
transmit second signaling indicating when RS will be transmitted in a transmission occasion of the second set of RS resources; and
receive a report indicating a time correlation metric calculated by the UE based on measurement of RS transmitted in the transmission occasion of the second set of RS resources, in accordance with the second signaling, and a measurement of RS transmitted in a transmission occasion of the first set of RS resources.

16. The apparatus of claim 15, wherein the time correlation metric is for a lag that represents a separation in time between the transmission occasion of the first set of RS resources and the transmission occasion of the second set of RS resources.

17. The apparatus of claim 16, wherein: the at least a second set of periodic RS resources comprises multiple sets of periodic RS resources; and a value of the lag determines the transmission occasion of one of the multiple sets of periodic RS resources.

18. The apparatus of claim 17, wherein: the first set of RS resources is configured with a first periodicity; and each of the multiple sets of periodic RS resources is configured with a periodicity that is an integer multiple of the first periodicity.

19. The apparatus of claim 18, wherein the one or more processors are further configured to execute the computer-executable instructions and cause the apparatus to:
determine the transmission occasion of the second set of RS resources used to calculate the time correlation metric based, at least in part, on: the value of the lag, a first offset associated with the first set of RS resources, a second offset associated with the second set of periodic RS resources, and the first periodicity.

20-29. (canceled)

30. A method for wireless communications at a network entity, comprising:
transmitting first signaling configuring a user equipment (UE) with a first set of reference signal (RS) resources for periodic transmission of RS and at least a second set of periodic RS resources for opportunistic transmission of RS;
transmitting second signaling indicating when RS will be transmitted in a transmission occasion of the second set of RS resources; and
receiving a report indicating a time correlation metric calculated by the UE based on measurement of RS transmitted in the transmission occasion of the second set of RS resources, in accordance with the second signaling, and a measurement of RS transmitted in a transmission occasion of the first set of RS resources.
